(19) United States
(12) Patent Application Publication
(10) Pub. No.: US 2024/0337478 A1
(43) Pub. Date: Oct. 10, 2024

(54) SYSTEM AND METHOD TO REDUCE MEASUREMENT ERROR IN INTERFEROMETRY-BASED METROLOGY

(71) Applicant: KLA Corporation, Milpitas, CA (US)

(72) Inventors: Yuchi Chen, Singapore (SG); Yicheng Lai, Singapore (SG)

(21) Appl. No.: 18/594,707

(22) Filed: Mar. 4, 2024

Related U.S. Application Data
(60) Provisional application No. 63/457,814, filed on Apr. 7, 2023.

(51) Int. Cl. G01B 9/02055; G01B 9/02; G01B 11/06

(52) U.S. Cl. CPC G01B 9/0207; G01B 9/02041; G01B 11/06

(57) ABSTRACT

A system includes a laser source and a dual interferometer sub-system. A channel of the dual interferometer sub-system includes a first splitter element coupled to a first output beam from a laser source configured to split the first output beam into a first transmitted beam and a first reflected beam, a first power sensor configured to measure a power of the first transmitted beam, a first detector configured to receive a first interference signal from the dual interferometer sub-system and record a first interferogram frame. The system includes a controller coupled to the first power sensor and the first detector of the first channel of the dual interferometer sub-system configured to receive the first interferogram frame, receive a first laser power measurement from the first power sensor; and normalize an intensity of the first interferogram frame based on the first laser power measurement to produce a first normalized interferogram frame.

### CROSS-REFERENCE TO RELATED APPLICATION

The present application claims the benefit under 35 U.S.C. § 119 (e) of U.S. Provisional Application Ser. No. 63/457,814, filed Apr. 7, 2023, naming Chen Yuchi and Lai Yicheng as inventors, which is incorporated herein by reference in the entirety.

### TECHNICAL FIELD

The present disclosure relates to the measurement of substrate shape and thickness variation with a dual interferometer and, in particular, to measuring and compensating for power variation in an interferometry-based metrology system variations

### BACKGROUND

Interferometry is a useful technique for measuring one or more spatial characteristics of a sample, such as a semiconductor wafer or any other semiconductor or non-semiconductor substrate, based on information associated with illumination reflected from test surfaces of the sample. As semiconductor fabrication continually requires higher levels of accuracy and precision, improved interferometry techniques are needed to meet the demands of modern fabrication technologies.

Measurements of the shape and thickness variation of wafer or thin film are often desired. Currently, the shape and thickness variation of a bare wafer is measured through methods that include dual interferometry measurements. Dual interferometry systems are sensitive to the power variation of the laser of the interferometer which can lead to increased variability and error in measurements that may significantly limit the effectiveness of the dual interferometry system. Therefore, it is desirable to provide a system and method that overcomes the shortfalls of the previous approaches discussed above.

### SUMMARY

A system is disclosed, in accordance with one or more embodiments of the present disclosure. In one embodiment, the system includes a laser source. In another embodiment, the system includes a dual interferometer sub-system including a first channel and a second channel. In another embodiment, the first channel of the dual interferometer sub-system includes: a first splitter element optically coupled to a first output beam from a laser source and configured to split the first output beam into a first transmitted beam and a first reflected beam; a first power sensor configured to measure a power of the first transmitted beam; a first detector configured to receive a first interference signal from the dual interferometer sub-system and record a first interferogram frame; and a controller communicatively coupled to the first power sensor and the first detector of the first channel of the dual interferometer sub-system. In another embodiment the controller includes one or more processors, wherein the one or more processors are configured to execute a set of program instructions stored in memory, the set of program instructions configured to cause the one or more processors to: receive the first interferogram frame from the first detector; receive a first laser power measurement from the first power sensor; and normalize an intensity of the first interferogram frame based on the first laser power measurement to produce a first normalized interferogram frame.

Another system is disclosed, in accordance with one or more embodiments of the present disclosure. In one embodiment, the system includes a dual interferometer sub-system configured to measure thickness variation across a substrate. In another embodiment, the system includes a controller communicatively coupled to the dual interferometer system, a first power sensor, and a first detector, the controller including one or more processors, wherein the one or more processors are configured to execute a set of program instructions stored in memory. In another embodiment, the set of program instructions configured to cause the one or more processors to: receive a first interferogram frame; receive a first laser power measurement; normalize an intensity of the first interferogram frame based on the first laser power measurement to produce a first normalized interferogram frame.

A method for measuring substrate thickness is disclosed, in accordance with one or more embodiments of the present disclosure. In one embodiment, the method includes receiving a first interferogram frame from a first detector of a first channel of a dual interferometer wafer geometry system. In another embodiment, the method includes receiving a first laser power measurement from a first power sensor of the first channel of the dual interferometer wafer geometry system. In another embodiment, the method includes normalizing an intensity of the first interferogram frame based on the first laser power measurement to produce a first normalized interferogram frame.

### BRIEF DESCRIPTION OF THE DRAWINGS

The numerous advantages of the disclosure may be better understood by those skilled in the art by reference to the accompanying figures.

FIG. 1 illustrates a conceptual view of system for measuring the thickness variation of a substrate or a film across a substrate, in accordance with one or more embodiments of the present disclosure.

FIG. 2A illustrates a simplified schematic view of a dual interferometer sub-system, in accordance with one or more embodiments of the present disclosure.

FIG. 2B illustrates a close-up conceptual view of one polarizing beam splitter and a respective power sensor, in accordance with one or more embodiments of the disclosure.

FIG. 2C illustrates a conceptual view of a Dual Fizeau cavity, in accordance with one or more embodiments of the present disclosure.

FIG. 3 illustrates a process flow diagram depicting a method for measuring a thickness variation of a substrate, in accordance with one or more embodiments of the present disclosure.

### DETAILED DESCRIPTION

Reference will now be made in detail to the subject matter disclosed, which is illustrated in the accompanying drawings.

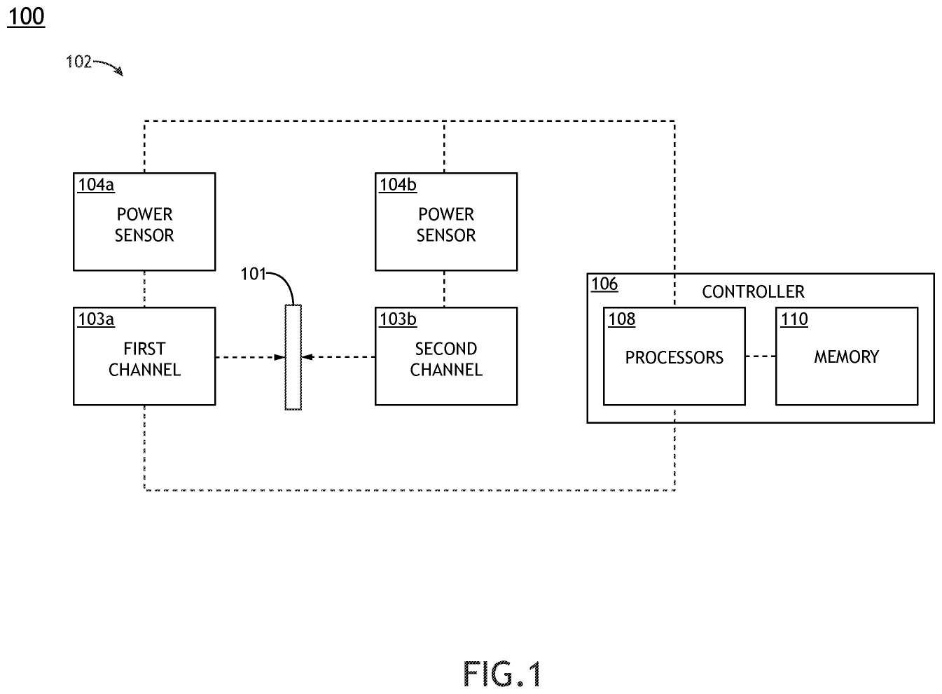

FIGS. 1 through 3 illustrate a system and method for measuring power variation in a dual interferometry system and compensating for the measured power variations, in accordance with one or more embodiments of the present disclosure. Embodiments of the present disclosure are directed to the utilization of a power sensor optically coupled to one or more channels of the dual interferometry system and configured to measure the power of an energy source (e.g., laser source) associated with the dual interferometry system. Embodiments of the present disclosure are also directed to utilizing power measurements from the power sensor in a normalization method where an interferogram frame is normalized based on the variations in the power measurements. The system and method reduce measurement errors in interferometry-based wafer geometry metrology systems that are induced by laser power variation.

Embodiments of the present disclosure are particularly advantageous as they can be implemented with minimal modifications to existing platform optic systems and software while providing an improvement in precision.

FIG. 1 illustrates a conceptual view of system 100 for measuring the thickness variation of a substrate or film across the substrate, in accordance with one or more embodiments of the present disclosure.

In embodiments, the system 100 includes a dual interferometer sub-system 102 (or dual interferometer tool) that includes a first channel 103a and a second channel 103b, one or more power sensors 104a-b, and a controller 106. In embodiments, the dual interferometer sub-system 102 is configured to measure flatness across a substrate 101. The substrate 101 may include any substrate known in the art including, but not limited to, a semiconductor wafer (e.g., silicon wafer). The substrate may be coated with one or more films and may include one or more pre-layers, as discussed in additional detail further herein.

In embodiments, the controller 106 includes one or more processors 108 and memory 110. For example, the memory 110 may maintain program instructions configured to cause the one or more processors 108 to carry out any of the one or more process steps described throughout the present disclosure.

In embodiments, the one or more processors 108 of the controller 106 are communicatively coupled to the dual interferometer sub-system 102 and the power sensor 104. In this regard, the one or more processors 108 are configured to receive measurement results from the dual interferometer sub-system 102 and the power sensor 104. In embodiments, the one or more processors are configured to determine a thickness variation of the substrate 101 as a function of position across the substrate 101 based on one or more flatness measurements received from the dual interferometer sub-system and one or more power measurements received from the power sensor 104. It is noted that the system 100 may be used to measure the thickness variation of a substrate and/or the thickness variation of a thin film deposited on a substrate with or without pre-layers, which is described in additional detail further herein.

The power sensor 104 may include any power or light sensor known in the art capable of measuring the power of a light source such as, but not limited to, a laser. For example, the power sensor 104 may include a photodetector. Photodetectors include, but are not limited to, metal-semiconductor-metal (MSM) photodetectors, photodiodes, avalanche photodiodes, phototransistors, charge-coupled devices, complementary metal-oxide semiconductor (CMOS) image sensors, and photomultiplier tubes.

The dual interferometer sub-system 102 may include any dual interferometer tool known in the art capable of measuring flatness across a substrate 101. For example, the dual interferometer sub-system 102 may include, but is not limited to, a dual wavelength dual Fizeau interferometer (DWDFI). The dual interferometer sub-system 102 system may be configured to measure any number of spatial characteristics of a substrate 101, such as, but not limited to, shape variation, thickness variation, and/or other spatial parameter variations of the sample. In embodiments, the dual interferometer sub-system 102 system may be adapted to perform patterned wafer geometry (PWG) measurements on a sample, whereby the dynamic range of the sample slope (e.g., wafer slope) measured by the dual interferometer sub-system 102 is extended by stitching different regions of the sample (e.g., wafer) measurement results together.

A description of a dual wavelength dual interferometer is described in U.S. Pat. No. 6,847,458, issued on Jan. 25, 2005, which is incorporated herein by reference in the entirety. A description of a dual wavelength dual interferometer is described in U.S. Pat. No. 8,068,234, issued on Nov. 29, 2011, which is incorporated herein by reference in the entirety. A description of a dual wavelength dual interferometer is described in U.S. Patent Publication No. 2014/0293291, published on Oct. 2, 2014, which is incorporated herein by reference in the entirety. A description of a dual wavelength dual interferometer used to measure the shape and thickness of high slope samples is described in U.S. Pat. No. 7,847,954, issued on Dec. 7, 2010, which is incorporated herein by reference in the entirety. It is recognized herein that the present disclosure may be extended to any phase-shifting interferometry system configured to utilize a wavelength-tunable illumination source for phase shifting. Accordingly, the following description of the dual interferometer sub-system 102 is not intended to limit the present disclosure in any way.

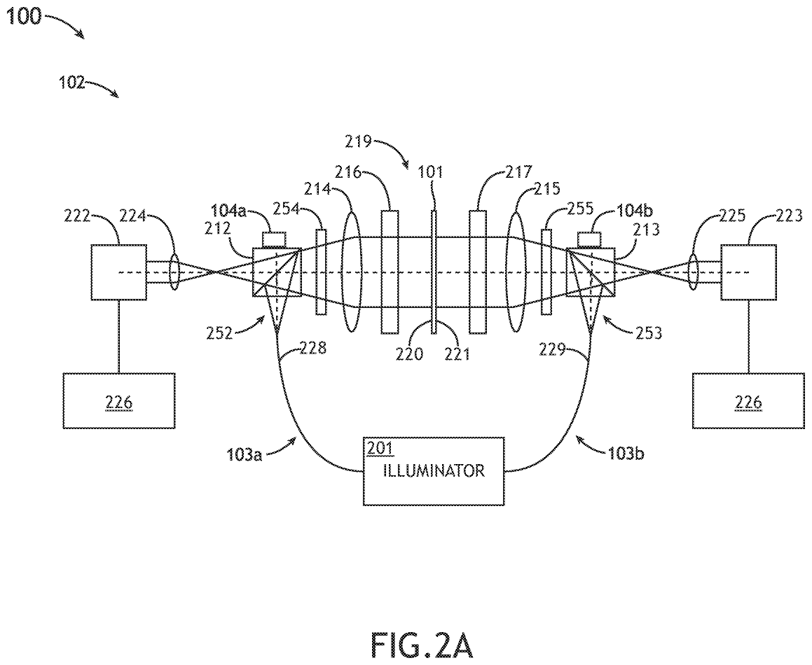

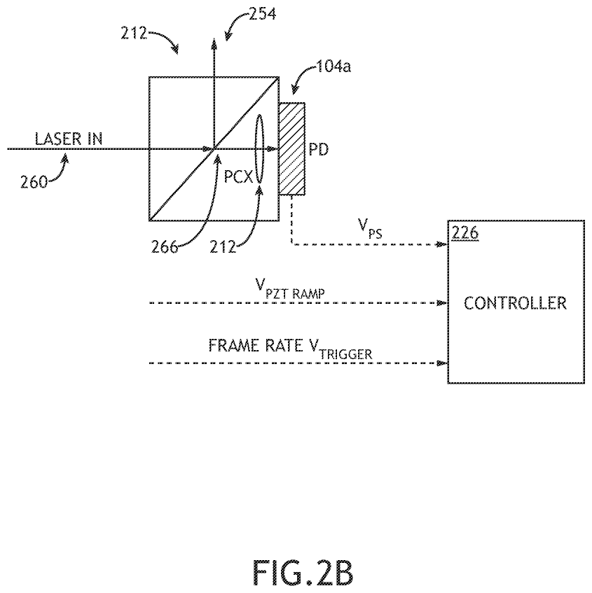

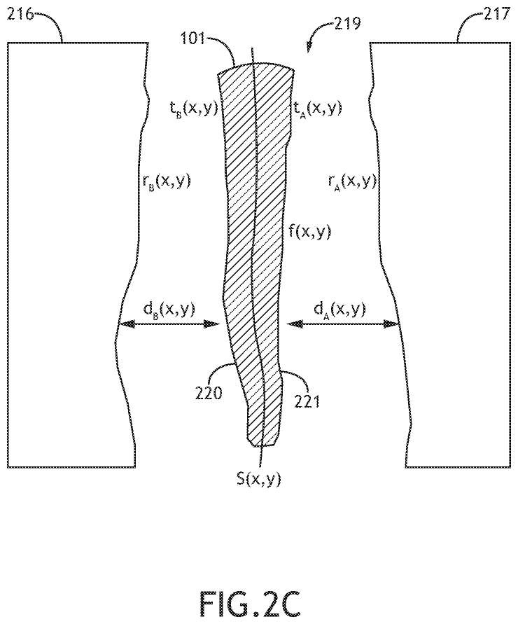

FIG. 2A illustrates a simplified schematic view of a dual interferometer sub-system 102, in accordance with one or more embodiments of the present disclosure.

In embodiments, the dual interferometer sub-system 102 includes an illumination source or illuminator 201, which is configured to provide light along the first channel 103a and the second channel 103b. In embodiments, the optical first and second channels 103a-b of the dual interferometer sub-system 102 include optical fibers 228 and 229 configured to transmit the light from the illumination source (e.g., illuminator 201) to the interferometer inputs 252 and 253. In embodiments, the interferometer inputs 252 and 253 include one or more optical elements connected in series with the one or more optical fibers 228 and 229. In embodiments, the interferometer inputs 252 and 253 may include the optical fibers 228 and 229. The interferometer inputs 252 and 253 may direct at least a portion of the light from the illuminator 201 to the dual interferometer sub-system 102.

In embodiments, the dual interferometer sub-system 102 includes one or more polarizing beam splitters 212, 213 configured to receive light from the interferometer inputs 252, 253. In embodiments, the beam splitters 212, 213 direct a portion of the light to quarter-wave plates 254, 255. Light passing through the polarizing beam splitters 212,213 and through the quarter-wave plates 254 and 255 may be circularly polarized. The circularly polarized light may then be received by lenses 214, 215 configured to collimate the light into beams having a diameter greater than a diameter of the substrate 101. The one or more lenses 214, 215 may also direct the collimated beams to reference flats 216,217 (e.g., parallel reference flats). The substrate 101 may be positioned in the center of the cavity 219 defined by the reference flats 216, 217. In embodiments, the collimated beams may be transmitted through the reference flats 216, 217 to substrate 101.

In embodiments, a first portion of each of the transmitted beams is directed to one or more surfaces 220, 221 of the substrate 101. Further, a second a portion of each of the transmitted beams is directed to the reference surfaces of the reference flats 216, 217 located opposite to the one or more transmitting reference flats 216, 217.

In embodiments, the dual interferometer sub-system 102 includes detectors 222, 223 (e.g., a first detector and a second detector). The detectors 222, 223 may include, but are not limited to, one or more CCD detectors, one or more TDI-CCD detectors, one or more CMOS detectors, a camera, or any other photodetectors known in the art. In embodiments, the detectors 222, 223 may be configured to detect and/or record portions of illumination reflected from the one or more surfaces 220, 221 of the substrate 101 (e.g., a first interference signal and a second interference signal). In embodiments, the detectors 222, 223 are configured to detect portions of light reflected from corresponding reference surfaces of reference flats 216, 217.

In embodiments, the dual interferometer sub-system 102 includes the one or more power sensors 104a-b. The one or more power sensors 104 are configured to measure a power of the output beam from the illuminator 201. The one or more power sensors 104a-b may measure the power of the output beam from one or more positions within the dual interferometer sub-system 102. For example, the one or more power sensors 104a-b may be configured to measure light that is transmitted though the one or more polarizing beam splitters 212, 213. The one or more power sensors 104a-b may be mechanically coupled to the one or more polarizing beam splitters 212, 213, may be bonded to the one or more polarizing beam splitters 212, 213, or may be set at a specific distance away from the surface of the one or more polarizing beam splitters 212, 213, with the one or power sensors 104a-b configured to receive the transmitted light.

In embodiments, the system 100 includes one or more controllers 226 communicatively coupled to the detectors 222, 223. In embodiments, the one or more controllers 226 acquire information associated with detected light from the detectors 222, 223. In embodiments, the controllers 126 may execute a measurement algorithm from program instructions stored on memory to determine one or more spatial characteristics of the substrate 101 based on measurements from the substrate 101. Measurement algorithms for determining spatial characteristics of samples with phase-shifting interferometry systems are known in the art. It is noted that any measurement process known in the art may be implemented with system 100 and the one or more controllers 226. Further, the one or more controllers 226 depicted in FIG. 2A may be embodied in controller 106, shown in FIG. 1, and vice-versa.

FIG. 2B illustrates a close-up conceptual view of one polarizing beam splitter 212 and a respective power sensor 104a, in accordance with one or more embodiments of the disclosure. As shown in FIG. 2B, the power sensor 104a is oriented relative to the polarizing beam splitter 212 so that when a first output beam 260 is split into a first transmitted beam 262 and a first reflected beam 264 and a first transmitted beam 266, the first transmitted beam 266 is in line with the power sensor 104a and the power of the first transmitted beam 266 is measured. The dual interferometer sub-system 102 may further include one or more plano-convex lenses (PCS) 268 may also be used for collimating or focusing the first transmitted beam 266 toward the power sensor 104a. Measurements from the power sensor 104a are then sent to the one or more controllers 106, 226. For example, voltage measurements from the power sensor (V_{PS}) may be received by the controller 226 via an “analog in” port or pin. The controller 226 may receive other signals including but not limited to laser tuning ramp signals (V_{PZT Ramp}) from piezoelectric stack transducers (PZT), and frame rate trigger voltage (V_{Trigger}) pulse signals.

In embodiments, the power sensors 104a-b are operable within one or more ranges or settings of one or more parameters (e.g., gain (measured in volt/ampere or V/A), bandwidth, and noise (measured in voltage). For example, the power sensors 104a-b may operate with a gain ranging from 1×10³ V/A to 1×10⁷ V/A, within a range of 1×10⁴ V/A to 1×10⁶ V/A, or within a range of 3×10⁴ V/A to 3×10⁵ V/A. For instance, the power sensors 104a-b may operate with a gain of approximately 0.75×10⁵ V/A. In another example, the power sensors 104a-b may operate with a bandwidth within a range of 1 kHz to 10 MHz, within a range of 10 kHz to 1 MHz, or within a range of 100 kHz to 500 MHz. For instance, the power sensors 104a-b may operate with a bandwidth of approximately 225 kHz. In another example, the power sensors 104a-b may operate with noise value in a range of 10 μV to 10 mV, within a range of 100 μV to 3 mV, or within a range of 300 μV to 1 mV. For instance, the power sensors 104a-b may operate with a noise of approximately 799 μV.

FIG. 2C illustrates a conceptual view of a Dual Fizeau cavity 219, in accordance with one or more embodiments of the present disclosure. As shown in FIG. 20, the Dual Fizeau cavity 219 may be configured to hold substrate 101 in a substantially vertical position. For instance, the Dual Fizeau cavity 219 may include a set of point contact devices (not shown) configured to receive and hold the wafer in a substantially upright position in a substantially free state. Utilizing the two reference flats 216 and 217, which serve as the reference surfaces for the interferometer, the Dual Fizeau interferometer may analyze various parameters associated with the substrate and its spatial relationship to the reference flats 216 and 217.

The dual interferometer sub-system 102 may simultaneously measure thickness variations of both the front-side surface 220 and back-side surface 221 of the substrate 101. The shape value at each of the measured points of the front-side and/or back-side surface may then be calculated utilizing the measured height variation at those points. The shape s(x,y) of the wafer as a function of X-Y position on the surface of the wafer may be expressed as a function of the cavity distance between the surfaces of the substrate 101 and the corresponding reference flats 216, 217.

In this case, d_{A}(x,y) represents the cavity distance between the first reference flat 217 of cavity 219 and a first side surface 220 (e.g., front-side) of the substrate, d_{B}(x,y) represents the cavity distance between the second reference flat 216 and a second side surface 221 (e.g., back-side) of the wafer. In this regard, the cavity distance d_{A}(x,y) variation is related to the difference between the thickness t_{A}(x,y) variation of the first side of the substrate and the variation of the surface of the reference flat r_{A}(x,y). Similarly, the cavity distance d_{B}(x,y) variation is related to the difference between the thickness t_{B}(x,y) variation of the second side surface 221 of the substrate and the variation of the surface of the reference flat r_{B}(x,y).

Utilizing these relationships a two-dimensional X-Y map of shape may be constructed by calculating shape at a plurality of positions on the substrate. Dual Fizeau interferometry suitable for measuring front-side and back-side topography of a substrate (e.g., semiconductor wafer) is described in detail in Klaus Freischlad et al., “Interferometry for Wafer Dimensional Metrology”, Proc. SPIE 6672, 1 (2007), which is incorporated herein by reference in the entirety. In addition, Dual sided interferometry is described generally in U.S. Pat. No. 6,847,458, issued on Jan. 25, 2005; U.S. Pat. No. 8,068,234, issued on Nov. 29, 2011, which are both incorporated herein by reference in the entirety.

In embodiments, the dual interferometer sub-system 102 is used to measure the shape and/or thickness variation of the substrate 101. The dual interferometer sub-system 102 can be sensitive to the power variation of the first output beam 260, which is due to the wavelength change when performing phase shifts, resulting in error. Methods for using power measurements from the one or more power sensors 104a-b to compensate for the power variation are provided below.

In embodiments, a model of phase-shifted fringe pattern with laser power instability considered can be represented as

$$I ( i , j ) = {I}_{o} ( i ) \{ 1 + V ( j ) cos [ ϕ ( j ) + δ ( i ) ] \} \qquad Eq . 1$$

where Iₒ is the background intensity which may have variation across frames (e.g., taken by the detectors 222, 223), V corresponds to the contrast of the pixel, i (e.g., subscript i) corresponds to the frame index and j (e.g., subscript j) corresponds to the pixel index, φ corresponds to phase of the wave being measured, and δ corresponds to the phase shift. Iₒ(i) is linearity related to the power of the output beam power and is monitored by the power sensor 104a-b. The power sensor 104a-b may take several power measurements exposure time of the detector 222, 223 at each frame trigger to obtain the mean power, P(i), read across the interferogram frame.

In embodiments, power variation detected in the interferogram frame can be normalized to generate a normalized interferogram frame. For example, laser power variation can be compensated for in an interferogram frame by electrically normalizing the intensity of the interferogram frame as:

$$\hat{l} ( i , j ) = \frac{\tilde{I} ( i , j )}{P ( i )} \times \overline{P} \qquad Eq . 2$$

where Ĩ corresponds to the intensity of the measured interferogram frame, Î corresponds to the intensity of the interferogram frame after normalization and the P̅ corresponds to the mean power across all interferogram frames. The intensity of the measured interferogram frame after normalization is therefore a product of the intensity of the measured interferogram frame (e.g., a first interferogram frame) and the mean power across all interferogram frames (the intensity of the first measured interferogram frame having been divided by the mean power of the first interferogram frame). After intensity normalization, the wafer geometry can be extracted, such as by the methods described in U.S. Pat. No. 6,847,458 as referenced above.

In embodiments, the one or more processors 108 of the controller 106 of system 100 may determine a thickness variation of the substrate 101 as a function of position across the substrate 101 based on one or more flatness measurements from the dual interferometer sub-system 102 and power measurements from the power sensor 104a-b. For example, the power measurements may be used to normalize electrically the intensity of the interferogram that is used in determining the thickness variation of the substrate. In embodiments, the one or more processors 108 receive one or more flatness measurements f(x,y) of the substrate 101 as a function of X-Y position across the substrate 101 from the dual interferometer sub-system 102 and one or more power measurements P of the output beam (e.g., first transmitted beam 266) from the power sensor 104a-b. In embodiments, the one or more processors 108 determine an average thickness of the substrate 101 based on the one or more power measurements. In embodiments, the one or more processors 108 determine the thickness variation t(x,y) of the substrate 101 as a function of position across the substrate 101 based on the one or more flatness measurements and the average thickness of the substrate 101.

In embodiments, the system 100 includes a user interface device communicatively coupled to the one or more processors 108 of controller 106. The user interface device may be utilized by controller 106 to accept information, selections and/or instructions from a user. For example, a display may be used to display data or a prompt to a user (not shown). In turn, a user may input information, a selection and/or instructions into the memory 110 of the controller 106 via the user interface device.

While the foregoing description has focused on a power sensor 104 placed in communication with the one or more processors 108, such a configuration is not a limitation on the scope of the embodiments of the present disclosure. In an alternative embodiment, the power information discussed previously herein may be entered into the memory 110 of the controller 106 by a user via user interface. In this regard, the various thickness variation calculations described previously herein may be carried out with the power information entered into memory 110 via user interface.

In embodiments, upon determining a thickness variation for the substrate 101, the one or more processors 108 may transmit one or more control/adjust instructions to one or more process tools. For example, in response to determining a thickness variation for the substrate 101 and/or the film 301 that deviates from a preferred thickness variation, the one or more processors 108 may adjust one or more parameters of a process tool along a semiconductor fabrication facility in order to mitigate observed deficiencies associated with the substrate, and/or final semiconductor device. In this regard, the one or more processors 108 may provide feedback information to upstream process tools to adjust process conditions for subsequent substrates, which follow the initial substrate along the semiconductor fabrication line. Further, the one or more processors 108 may provide feedforward information to downstream process tools to adjust process conditions for the substrate in question as it progresses along the semiconductor fabrication line.

In embodiments, upon determining/monitoring an intensity of the first channel 103a and/or second channel 103b or normalizing the intensity of the interferogram frame, the one or more processors 108 may transmit one or more control/adjust instructions to the one or more components of the system 100 (e.g., the illuminator 201) or one or more process tools. For example, in response to determining an increased laser power variation, the one or more processors 108 may adjust one or more parameters of the illuminator 201 (e.g., output intensity or wavelength). In this regard, the one or more processors 108 may provide feedback information to the illuminator 201 to adjust process conditions for subsequent substrates.

The one or more processors 108 of controller 106 may include any one or more processing elements known in the art. In this sense, the one or more processors 108 may include any microprocessor-type device configured to execute software algorithms and/or instructions. In embodiments, the one or more processors 108 may consist of a desktop computer, mainframe computer system, workstation, image computer, parallel processor, or other computer system (e.g., networked computer) configured to execute a program configured to operate the system 100, as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from a non-transitory memory medium 110. Moreover, different subsystems of the system 100 (e.g., dual interferometer sub-system/tool 102, mass sensor 104, or user interface) may include a processor or logic elements suitable for carrying out at least a portion of the steps described throughout the present disclosure.

The memory medium 110 may include any memory medium known in the art suitable for storing program instructions executable by the associated one or more processors 108. For example, the memory medium 110 may include, but is not limited to, a read-only memory, a random-access memory, a magnetic or optical memory device (e.g., disk), a magnetic tape, a solid-state drive and the like. In embodiments, the memory medium 110 is configured to store one or more results from the dual interferometer sub-system 102 and/or the mass sensor 104 and/or the output of the various data processing steps described herein. It is further noted that memory medium 110 may be housed in a common controller housing with the one or more processors 108. In an alternative embodiment, the memory medium 110 may be located remotely with respect to the physical location of the processors and controller 106. For instance, the one or more processors 108 of controller 106 may access a remote memory (e.g., server), accessible through a network (e.g., internet, intranet and the like).

It is further noted that, while FIG. 1 depicts the controller 106 as being embodied separately from the dual interferometer sub-system 102 and mass sensor 104, such a configuration of system 100 is not a limitation on the scope of the present disclosure, but is provided merely for illustrative purposes. For example, the controller 106 may be embodied in a controller of the dual interferometer sub-system 102 and/or the mass sensor 104.

The user interface device may include any user interface known in the art. For example, the user interface may include, but is not limited to, a keyboard, a keypad, a touchscreen, a lever, a knob, a scroll wheel, a track ball, a switch, a dial, a sliding bar, a scroll bar, a slide, a handle, a touch pad, a paddle, a steering wheel, a joystick, a bezel input device or the like.

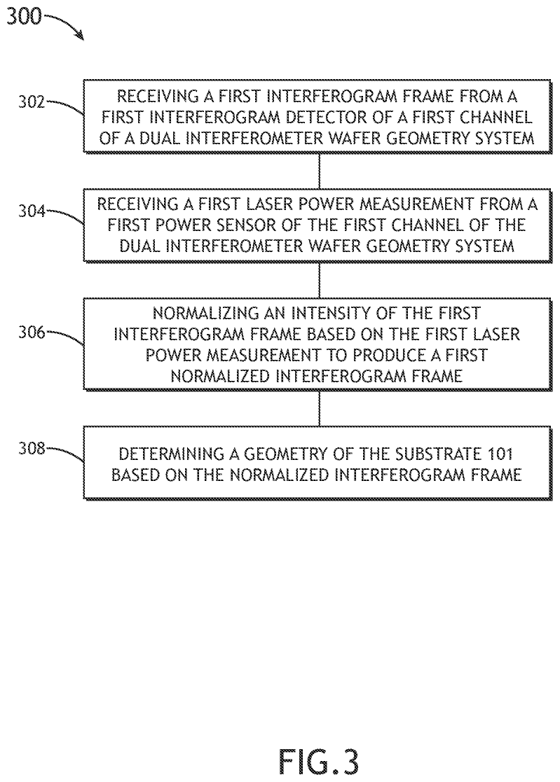

FIG. 3 illustrates a process flow diagram depicting a method 300 for measuring a thickness variation of a substrate, in accordance with one or more embodiments of the present disclosure. One or more steps of the method 300 may be performed by one or more processors 108 of the controller 106, 226 (e.g., the one or more processors 108 being configured to execute a set of program instructions for one or more steps of the method 300 that are stored in memory 110). In embodiments, the method 300 includes a step 302 of receiving a first interferogram frame from a first detector 222 of a first channel 103a of a dual interferometer wafer geometry system 100. In embodiments, the method 300 includes a step 304 of receiving a first laser power measurement from a first power sensor 104a of the first channel 103a of the dual interferometer wafer geometry system 100. In embodiments, the method 300 includes a step 306 of normalizing an intensity of the first interferogram frame based on the first laser power measurement to produce a first normalized interferogram frame. Normalizing the intensity of first interferogram frame may include normalization algorithms described herein, such as an algorithm that includes, at least on part, equation 2. In embodiments, the method includes a step 308 of determining a geometry of the substrate 101 based on the normalized interferogram frame.

The method 300 may further include steps of receiving a second interferogram frame from a second detector 227, receiving a second laser power measurement from a second power sensor 104b, and normalizing an intensity of the second interferogram frame based on the second laser power measurement to produce a second normalized interferogram frame. The method 300 may then include a step of determining a geometry (e.g., shape and/or thickness) of the substrate 101 based on the first normalized interferogram frame and the second normalized interferogram frame. In dual interferometer wafer geometry systems 100 where only one power sensor 104a is used, the determined geometry of the substrate 101 may be based on a first normalized interferogram frame. For example, the geometry of the substrate 101 may be determined based on a first normalized interferogram frame from the first detector 222 and a second non-normalized interferogram frame from the second detector 223.

While implementations of the method 300 are discussed herein, it is further contemplated that various steps of the method 300 may be included, excluded, rearranged, and/or implemented in many ways without departing from the essence of the present disclosure. Accordingly, the foregoing embodiments and implementations of the method 300 are included by way of example only and are not intended to limit the present disclosure in any way.

All of the methods described herein may include storing results of one or more steps of the method embodiments in a memory medium. The results may include any of the results described herein and may be stored in any manner known in the art. The memory medium may include any memory medium described herein or any other suitable memory medium known in the art. After the results have been stored, the results can be accessed in the memory medium and used by any of the method or system embodiments described herein, formatted for display to a user, used by another software module, method, or system, etc. Furthermore, the results may be stored “permanently,” “semi-permanently,” temporarily,” or for some period of time. For example, the memory medium may be random access memory (RAM), and the results may not necessarily persist indefinitely in the memory medium.

It is further contemplated that each of the embodiments of the method described above may include any other step(s) of any other method(s) described herein. In addition, each of the embodiments of the method described above may be performed by any of the systems described herein.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable and/or wirelessly interacting components, and/or logically interacting and/or logically interactable components.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

What is claimed:

1. A system comprising:
a laser source;
a dual interferometer sub-system comprising a first channel and a second channel, wherein the first channel of the dual interferometer sub-system comprises:
a first splitter element optically coupled to a first output beam from a laser source and configured to split the first output beam into a first transmitted beam and a first reflected beam;
a first power sensor configured to measure a power of the first transmitted beam; and
a first detector configured to receive a first interference signal from the dual interferometer sub-system and record a first interferogram frame; and
a controller communicatively coupled to the first power sensor and the first detector of the first channel of the dual interferometer sub-system, the controller including one or more processors, wherein the one or more processors are configured to execute a set of program instructions stored in memory, the set of program instructions configured to cause the one or more processors to:
receive the first interferogram frame from the first detector;
receive a first laser power measurement from the first power sensor; and
normalize an intensity of the first interferogram frame based on the first laser power measurement to produce a first normalized interferogram frame.

2. The system of claim 1, wherein the first laser power measurement comprises a mean of a plurality of power measurements.

3. The system of claim 1, wherein normalizing an intensity of the first interferogram frame comprises calculating a product of a mean power of all interferogram frames and an intensity of the first interferogram frame.

4. The system of claim 1, wherein the second channel of the dual interferometer sub-system comprises:
a second splitter element coupled to a second output beam of a second laser source configured to split the second output beam into a second transmitted beam and a second reflected beam;
a second power sensor configured to measure a power of the second transmitted beam; and
a second detector configured to receive a second interference signal from the dual interferometer sub-system and record a second interferogram frame.

5. The system of claim 1, wherein the one or more processors are further configured to:
determine a geometry of a substrate based on the first normalized interferogram frame and at least one of a second interferogram frame or a second normalized interferogram frame.

6. The system of claim 5, wherein the substrate comprises:
a semiconductor wafer.

7. The system of claim 1, wherein the dual interferometer sub-system comprises:
a dual wavelength dual Fizeau interferometer (DWDFI) sub-system.

8. The system of claim 1, wherein the first power sensor comprises a photodetector.

9. The system of claim 1, wherein the first detector comprises a camera.

10. A system comprising:
a dual interferometer sub-system configured to measure thickness variation across a substrate; and
a controller communicatively coupled to the dual interferometer sub-system, a first power sensor, and a first detector, the controller including one or more processors, wherein the one or more processors are configured to execute a set of program instructions stored in memory, the set of program instructions configured to cause the one or more processors to:
receive a first interferogram frame;
receive a first laser power measurement; and
normalize an intensity of the first interferogram frame based on the first laser power measurement to produce a first normalized interferogram frame.

11. The system of claim 10, wherein normalizing an intensity of the first interferogram frame comprises calculating a product of a mean power of all interferogram frames and an intensity of the first interferogram frame.

12. The system of claim 10, the controller further communicatively coupled to a second power sensor and a second detector, the set of program instructions further configured to cause the one or more processors to:
receive a second interferogram frame;
receive a second laser power measurement; and
normalize the intensity of the second interferogram frame based on the second laser power measurement to produce a second normalized interferogram frame.

13. The system of claim 10, wherein the one or more processors are further configured to:
determine a geometry of the substrate based on the first normalized interferogram frame and at least one of a second interferogram frame or a second normalized interferogram frame.

14. The system of claim 10, wherein the dual interferometer sub-system comprises:
a dual wavelength dual Fizeau interferometer (DWDFI) sub-system.

15. The system of claim 10, further comprising the first power sensor, wherein the first power sensor comprises a photodetector.

16. The system of claim 10, further comprising the first detector, wherein the first detector comprises a camera.

17. The system of claim 10, wherein the substrate comprises:
a semiconductor wafer.

18. A method for measuring substrate thickness comprising:
receiving a first interferogram frame from a first detector of a first channel of a dual interferometer wafer geometry system;
receiving a first laser power measurement from a first power sensor of the first channel of the dual interferometer wafer geometry system; and
normalizing an intensity of the first interferogram frame based on the first laser power measurement to produce a first normalized interferogram frame.

19. The method of claim 18, wherein the first laser power measurement comprises a mean of a plurality of power measurements.

20. The method of claim 18, further comprising:
receiving a second interferogram frame from a second detector;
receiving a second laser power measurement from a second power sensor; and
normalizing an intensity of the second interferogram frame based on the second laser power measurement to produce a second normalized interferogram frame.

21. The method of claim 18, wherein normalizing an intensity of the first interferogram frame comprises calculating a product of a mean power of all interferogram frames and an intensity of the first interferogram frame.

22. The method of claim 20, further comprising:
determining a geometry of a substrate based on the first normalized interferogram frame and the second normalized interferogram frame.

23. The method of claim 18, further comprising:
determining a geometry of a substrate based on the first normalized interferogram frame and at least one of a second interferogram frame or a second normalized interferogram frame.
